(19) United States
(12) Patent Application Publication
(10) Pub. No.: US 2024/0037672 A1
(43) Pub. Date: Feb. 1, 2024

(54) ORDER MANAGEMENT APPARATUS, SYSTEM, METHOD, AND PROGRAM

(71) Applicant: NEC Platforms, Ltd., Kawasaki-shi (JP)

(72) Inventors: Rikako IWAMOTO, Kanagawa (JP); Haruo YOSHIDA, Kanagawa (JP); Takatsugu YAMANAKA, Kanagawa (JP); Yuka YOKOMICHI, Kanagawa (JP)

(73) Assignee: NEC Platforms, Ltd., Kawasaki-shi (JP)

(21) Appl. No.: 18/224,965

(22) Filed: Jul. 21, 2023

(30) Foreign Application Priority Data
Jul. 26, 2022 (JP) 2022-118353

(51) Int. Cl. G06Q 40/12; G06Q 50/12

(52) U.S. Cl. CPC G06Q 40/12; G06Q 50/12

(57) ABSTRACT

A clearing instruction after accounting is completed is automatically sent. An order management apparatus includes: an order entry unit configured to transmit, when order data including dish data and serving destination data is input, the order data to a kitchen apparatus; an order data storage unit configured to store the order data; a serving control unit configured to generate, when cooking of the dish is completed, serving instruction data including serving destination data of the dish and transmit the serving instruction data to a serving robot; an accounting unit configured to perform accounting based on the order data; and a clearing control unit configured to generate clearing instruction data including the serving destination data of the serving destination for which the accounting has been completed and transmitting the clearing instruction data to the serving robot.

### INCORPORATION BY REFERENCE

This application is based upon and claims the benefit of priority from Japanese patent application No. 2022-118353, filed on Jul. 26, 2022, the disclosure of which is incorporated herein in its entirety by reference.

### TECHNICAL FIELD

The present disclosure relates to an order management apparatus, a system, a method, and a program.

### BACKGROUND ART

In recent years, in order to improve an entire operation in a floor in an eating place, techniques for serving and clearing food and dishes using a serving robot have been developed. For example, Japanese Unexamined Patent Application Publication No. H11-143951 (Patent Literature 1) discloses a technique for transmitting a moving instruction from a kitchen controller and a handy terminal to a serving robot.

In order to further improve an entire operation, it may be considered to automatically send a serving instruction and a clearing instruction to a serving robot. The aforementioned Patent Literature 1 discloses a technique for transmitting, when information indicating that cooking of a dish has been completed is input, serving data of and a serving instruction for this dish to a serving robot. According to the technique according to Patent Literature 1, however, a clearing instruction after accounting is completed needs to be manually sent, and therefore the clearing instruction has not been sufficiently automated.

### SUMMARY

The present disclosure has been made in view of the aforementioned problem and an aim of the present disclosure is to provide an order management apparatus, a system, a method, and a program capable of automatically sending a clearing instruction after accounting is completed.

An order management apparatus according to the present disclosure includes: order entry means for transmitting, when order data including dish data and serving destination data is input, the order data to a kitchen apparatus; order data storage means for storing the order data; serving control means for generating, when cooking of a dish is completed, serving instruction data including serving destination data of the dish and transmitting the serving instruction data to a serving robot; accounting means for performing accounting based on the order data; and clearing control means for generating clearing instruction data including the serving destination data of the serving destination for which the accounting has been completed and transmitting the clearing instruction data to the serving robot.

An order management system according to the present disclosure includes: an order input terminal configured to input order data including dish data and serving destination data; an order management apparatus capable of communicating with the order input terminal; a serving robot that is configured to carry a cooked dish and is capable of communicating with the order management apparatus; and a kitchen apparatus capable of communicating with the order management apparatus, in which the order management apparatus includes: order entry means for transmitting, after receiving the order data from the order input terminal, the order data to the kitchen apparatus; order data storage means for storing the order data; serving control means for generating, after receiving information indicating that cooking of the dish has been completed from the kitchen apparatus, serving instruction data including serving destination data of the dish and transmitting the serving instruction data to a serving robot; accounting means for performing accounting based on the order data; and clearing control means for generating clearing instruction data including the serving destination data of the serving destination for which the accounting has been completed and transmitting the clearing instruction data to the serving robot.

In an order management method according to the present disclosure, a computer performs the following processing of: transmitting, when order data including dish data and serving destination data is input, the order data to a kitchen apparatus; storing the order data; generating, when cooking of a dish is completed, serving instruction data including serving destination data of the dish, and transmitting the serving instruction data to a serving robot; performing accounting based on the order data; and generating clearing instruction data including the serving destination data of the serving destination for which the accounting has been completed and transmitting the clearing instruction data to the serving robot.

An order management program according to the present disclosure causes a computer to execute: transmission processing for transmitting, when order data including dish data and serving destination data is input, the order data to a kitchen apparatus; storing processing for storing the order data; transmission processing for generating, when cooking of a dish is completed, serving instruction data including serving destination data of the dish, and transmitting the serving instruction data to a serving robot; accounting processing for performing accounting based on the order data; and transmission processing for generating clearing instruction data including the serving destination data of the serving destination for which the accounting has been completed and transmitting the clearing instruction data to the serving robot.

### BRIEF DESCRIPTION OF DRAWINGS

The above and other objects, features and advantages of the present disclosure will become more fully understood from the detailed description given hereinbelow and the accompanying drawings which are given by way of illustration only, and thus are not to be considered as limiting the present disclosure.

FIG. 1 is a block diagram showing a configuration of an order management apparatus according to a first exemplary embodiment;

FIG. 2 is a flowchart showing one example of a flow of an order management method according to the first exemplary embodiment;

FIG. 3 is a block diagram showing a configuration of an order management system according to a second exemplary embodiment;

FIG. 4 is a block diagram showing a configuration of a customer terminal included in the order management system according to the second exemplary embodiment;

FIG. 5 is a block diagram showing a configuration of a staff terminal included in the order management system according to the second exemplary embodiment;

FIG. 6 is a block diagram showing a configuration of a serving robot included in the order management system according to the second exemplary embodiment;

FIG. 7 is a block diagram showing a configuration of a kitchen apparatus included in the order management system according to the second exemplary embodiment;

FIG. 8 is a flowchart showing an operation example of an order management apparatus from a order of dishes to completion of serving in an order management method according to the second exemplary embodiment;

FIG. 9 is a sequence chart showing one example of a flow of processing from the order of dishes to the completion of serving in the order management method according to the second exemplary embodiment;

FIG. 10 is a diagram showing one example of an order data display screen in the order management system according to the second exemplary embodiment;

FIG. 11 is a diagram showing one example of a serving notification screen in the order management system according to the second exemplary embodiment;

FIG. 12 is a diagram showing one example of a serving instruction screen in the order management system according to the second exemplary embodiment;

FIG. 13 is a flowchart showing an operation example of an order management apparatus from accounting to the completion of clearing in the order management method according to the second exemplary embodiment;

FIG. 14 is a sequence chart showing one example of a flow of processing from the accounting to the completion of clearing in the order management method according to the second exemplary embodiment;

FIG. 15 is a sequence chart showing one example of a flow of processing from the accounting to the completion of clearing in a case in which the serving robot is in operation in the order management method according to the second exemplary embodiment;

FIG. 16 is a diagram showing one example of a staff terminal in the order management system according to the second exemplary embodiment;

FIG. 17 is one example of a serving robot selection screen in the order management system according to the second exemplary embodiment;

FIG. 18 is one example of a serving robot moving request screen in the order management system according to the second exemplary embodiment;

FIG. 19 is one example of a display screen of a customer terminal in the order management system according to the second exemplary embodiment;

FIG. 20 is one example of a staff calling screen in the order management system according to the second exemplary embodiment;

FIG. 21 is a block diagram showing a configuration of an order management system according to a third exemplary embodiment;

FIG. 22 is a block diagram showing a configuration of a customer terminal included in the order management system according to the third exemplary embodiment;

FIG. 23 is a flowchart showing an operation example of an order management apparatus from accounting to completion of clearing in an order management method according to the third exemplary embodiment;

FIG. 24 is a sequence chart showing one example of a flow of processing from the accounting to the completion of clearing in the order management method according to the third exemplary embodiment; and

FIG. 25 is a sequence chart showing one example of a flow of processing from completion of cooking to completion of serving in an order management method according to a fourth exemplary embodiment.

### EXAMPLE EMBODIMENTS

Hereinafter, with reference to the drawings, example embodiments of the present disclosure will be described in detail. Throughout the drawings, the same or corresponding elements are denoted by the same reference symbols and overlapping descriptions will be omitted as necessary for the sake of clarification of the description.

### First Exemplary Embodiment

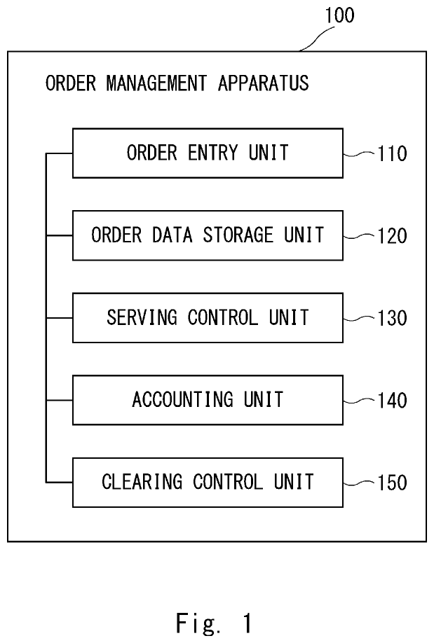

FIG. 1 is a block diagram showing a configuration of an order management apparatus according to a first exemplary embodiment. An order management apparatus 100 includes an order entry unit 110, an order data storage unit 120, a serving control unit 130, an accounting unit 140, and a clearing control unit 150.

After the order entry unit 110 receives order data from an order input terminal (not shown), the order entry unit 110 transmits the order data to a kitchen apparatus (not shown). The order data includes dish data and serving destination data. The dish data is data of dishes that a customer has ordered. The serving destination data is data for identifying a customer seat where the customer who has ordered the dishes is seated. The order input terminal is a terminal that can be operated by a floor staff member or a customer. The kitchen apparatus is an apparatus that is placed in a kitchen of an eating place. The floor staff member is a staff member who provides services and so on for customers in the floor in the eating place. A cooking staff member checks the order data from the kitchen apparatus and cooks the dishes. The order data storage unit 120 stores the order data. That is, the order data storage unit 120 stores the serving destination data in association with the dish data.

After cooking of the dishes is completed, the serving control unit 130 generates serving instruction data including serving destination data of the dishes and transmits the serving instruction data to a serving robot (not shown). For example, after the serving control unit 130 receives a dish cooking completion registration request from the kitchen apparatus, the serving control unit 130 generates serving instruction data including the serving destination data based on the cooking completion registration request. The serving robot is a robot capable of moving in an eating place. Thus the serving robot can carry the cooked dishes from the kitchen to customer seats.

The accounting unit 140 performs accounting based on the order data. The accounting unit 140 calculates the total bill by acquiring the dish data associated with the serving destination data from the order data storage unit 120 and executes payment processing. The clearing control unit 150 generates clearing instruction data including serving destination data of the serving destination for which accounting has been performed, and transmits the clearing instruction data to the serving robot. For example, the clearing control unit 150 acquires the serving destination data of the serving destination for which the accounting unit 140 has performed accounting from the order data storage unit 120 and generates clearing instruction data.

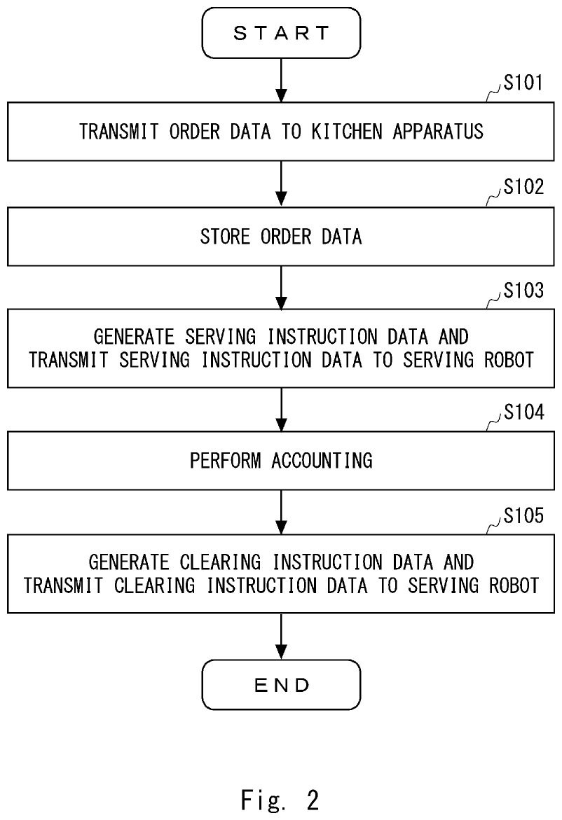

FIG. 2 is a flowchart showing a flow of an order management method according to the first exemplary embodiment. First, the order entry unit 110 transmits, when order data including dish data and serving destination data is input, the order data to the kitchen apparatus (Step S101). Next, the order data storage unit 120 stores the order data (Step S102). Next, the serving control unit 130 generates, when cooking of a dish is completed, serving instruction data including serving destination data of the dish, and transmits the serving instruction data to the serving robot (Step S103). Next, the accounting unit 140 performs accounting based on the order data (Step S104). Next, the clearing control unit 150 generates clearing instruction data including serving destination data of the serving destination for which accounting has been performed, and transmits the clearing instruction data to the serving robot (Step S105).

As described above, in the order management method according to the first exemplary embodiment, the clearing instruction data is automatically transmitted to the serving robot after accounting is completed. Therefore, a floor staff member does not need to input a clearing instruction after accounting is completed, and thus it is possible to improve the entire operation in the floor in the eating place.

The order management apparatus 100 includes, as components that are not shown, a processor, a memory, and a storage apparatus. Further, this storage apparatus stores a computer program in which processing of the order management method according to this example embodiment is implemented. Then, the processor causes a computer program to be loaded into the memory from the storage apparatus and executes this computer program. Accordingly, the processor implements the functions of the order entry unit 110, the order data storage unit 120, the serving control unit 130, the accounting unit 140, and the clearing control unit 150.

Alternatively, each of the components of the order management apparatus 100 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), a quantum processor (quantum computer control chip) and so on may be used as a processor.

Further, when some or all of the components of the order management apparatus 100 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which the apparatuses or the like are connected to each other through a communication network. Alternatively, the functions of the order management apparatus 100 may be provided in the form of Software as a Service (SaaS).

### Second Exemplary Embodiment

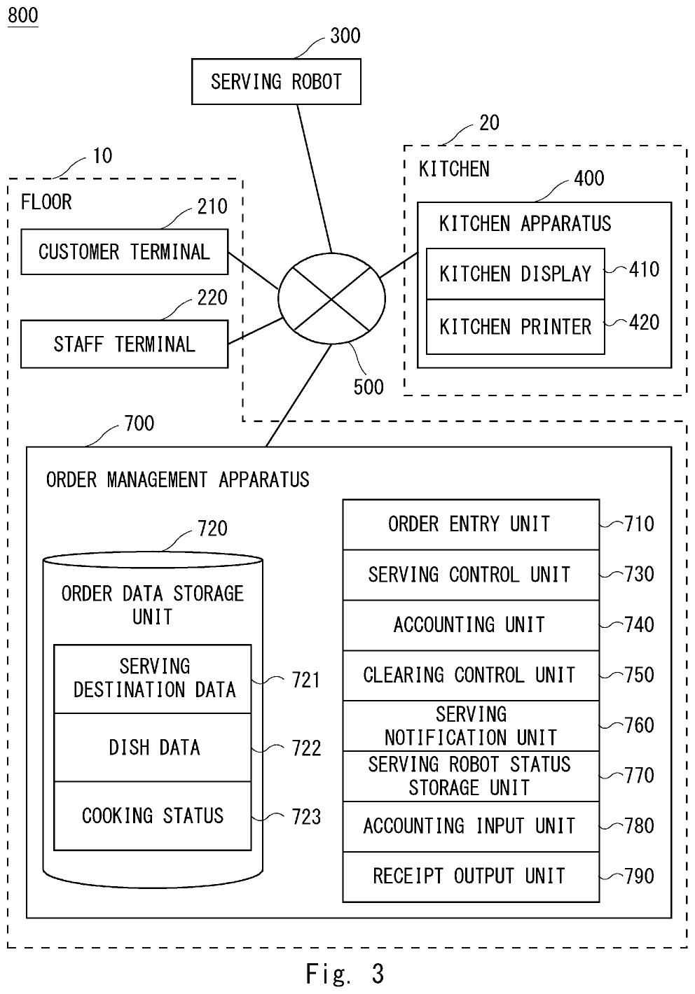

FIG. 3 is a block diagram showing a configuration of an order management system 800 according to a second exemplary embodiment. The order management system 800 is an information system that manages a cooking status of a dish ordered in a floor 10 in an eating place and accounting. The order management system 800 includes a customer terminal 210, a staff terminal 220, a serving robot 300, a kitchen apparatus 400, and an order management apparatus 700. Note that a plurality of customer terminals 210, a plurality of staff terminals 220, and a plurality of serving robots 300 may be provided. The customer terminal 210, the staff terminal 220, the serving robot 300, the kitchen apparatus 400, and the order management apparatus 700 are connected to one another via a network 500 in such a way that they can communicate with one another. The network 500 may be a wired or wireless communication line and may include the Internet.

The eating place includes the floor 10 and a kitchen 20. The floor 10 is provided with customer seats. A plurality of customer seats are generally provided in the floor 10. The customer seat may either be a seat that can be seated by a plurality of persons or may be a seat that can be seated by only one person. The customer seat that can be seated by a plurality of persons is, for example, a seat at a table. The customer seat seated by only one person is, for example, a seat at a counter. A customer seats on a customer seat provided in the floor 10 and orders dishes at the customer seat, receives the cooked dishes, and eats. The kitchen 20 is a space where the ordered dishes are cooked.

The customer terminal 210, which is a communication terminal provided in a customer seat, can be operated by a customer who is seated on the customer seat. When a plurality of customer seats are provided in the floor 10, the customer terminal 210 is provided in each customer seat. The customer terminal 210 is, for example, an information processing apparatus including a wireless communication function such as a mobile telephone, a smartphone, or a tablet terminal. The customer terminal 210 transmits a clearing request to the order management apparatus 700. Further, when cooking of a dish is completed, the customer terminal 210 displays a serving notification.

The staff terminal 220 is one example of the above-described order input terminal. The staff terminal 220 is a communication terminal held by a floor staff member. The floor staff member is a staff member who takes customers to their customer seats, takes orders, performs accounting and so on in the floor 10. When there are a plurality of floor staff members, each of the floor staff members holds the staff terminal 220. The staff terminal 220 is, for example, an information processing apparatus including a wireless communication function such as a handy terminal or a smart phone. In the second exemplary embodiment, a floor staff member takes an order for dishes from a customer and inputs the order data into the staff terminal 220. The order data includes dish data and serving destination data. The dish data is data of dishes that a customer orders. The serving destination data is data for identifying the customer seat seated by the customer. The staff terminal 220 transmits the input data of dishes to the order management apparatus 100 and causes the order management apparatus 100 to register the input data.

The serving robot 300 is a robot capable of moving in the floor 10. After the cooked dishes are placed on the serving robot 300, the serving robot 300 moves to the customer seat in the floor 10 in accordance with the serving instruction data received from the order management apparatus 700. Further, the serving robot 300 moves to the customer seat in accordance with clearing instruction data received from the order management apparatus 700. After clearing of the dishes is completed, the serving robot 300 moves to a dish return place.

The kitchen apparatus 400, which is an information terminal provided in the kitchen 20, can be operated by a cooking staff member. The kitchen apparatus 400 displays ordered dishes, outputs order slips, performs cooking completion registration, and so on. The kitchen apparatus 400 includes a kitchen display 410 and a kitchen printer 420. The kitchen display 410 receives order data and a cooking status from the order management apparatus 700 and displays the ordered data and the cooking status. The cooking status is a cooking status of each dish included in the order data. The kitchen printer 420 outputs an order slip of the dish data included in the order data received from the order management apparatus 700. The cooking staff member is a staff member who is in charge of cooking and the like of dishes in the kitchen 20. The cooking staff member cooks dishes according to the dish data displayed on the kitchen display 410. After the cooking staff member completes cooking of the dish, the cooking staff member places the cooked dish and the output order slip on the serving robot 300 and sends a dish cooking completion registration request from the kitchen display 410 or the kitchen printer 420. The cooking completion registration request includes dish data and serving destination data of the dishes that have already been cooked.

The order management apparatus 700 is one example of the aforementioned order management apparatus 100. The order management apparatus 700, which is an information processing apparatus that performs, for example, storage of ordered dishes, serving control, accounting, clearing control, and the like, and may be, for example, a server apparatus implemented by a computer. The order management apparatus 700 may be implemented in a plurality of servers in a redundant manner, and each function block may be implemented by a plurality of computers. The order management apparatus 700 includes an order entry unit 710, an order data storage unit 720, a serving control unit 730, an accounting unit 740, a clearing control unit 750, a serving notification unit 760, a serving robot status storage unit 770, an accounting input unit 780, and a receipt output unit 790.

After the order entry unit 710 receives the order data from the staff terminal 220, the order entry unit 710 transmits the received order data to the kitchen apparatus 400. After the order data storage unit 720 receives the order data from the staff terminal 220, the order data storage unit 720 stores the received order data. The order data storage unit 720 associates dish data 722 and a cooking status 723 with serving destination data 721 and stores these data items. The serving destination data 721 is data for identifying customer seats provided in the floor 10. The serving destination data 721 is, for example, customer seat numbers allocated to the respective customer seats. Hereinafter, the serving destination data may be referred to as a customer seat number. The serving destination data 721 is normally stored in the order data storage unit 720 in advance. The dish data 722 is data of dishes ordered in each customer seat. The cooking status 723 is a cooking status of each of the dishes that have been ordered.

After the serving notification unit 760 receives the dish cooking completion registration request from the kitchen display 410 or the kitchen printer 420, the serving notification unit 760 transmits a serving notification to the customer terminal 210. When a plurality of customer seats are provided in the floor 10, the cooking completion registration request includes serving destination data, and the serving notification unit 760 transmits a serving notification to the customer terminal 210 provided in the customer seat corresponding to the serving destination data. The serving notification includes, for example, a message for notifying the customer of information indicating that the ordered dish will be served shortly, such as “The item will arrive shortly”. After the serving control unit 730 receives the dish cooking completion registration request from the kitchen display 410 or the kitchen printer 420, the serving control unit 730 generates serving instruction data and transmits the generated serving instruction data to the serving robot 300. The serving instruction data includes serving destination data included in the cooking completion registration request.

In the second exemplary embodiment, when a customer tells a floor staff member that he/she wants to pay the bill, the floor staff member operates the order management apparatus 700 to proceed to accounting. After knowing that the customer wants to pay the bill, the floor staff member operates the accounting input unit 780. The accounting input unit 780 causes the accounting unit 740 to perform accounting according to the operation performed by the floor staff member. For example, the floor staff member inputs the customer seat number (serving destination data) into the accounting input unit 780, and then the accounting input unit 780 requests the accounting unit 740 to perform accounting for the customer seat corresponding to the customer seat number. The accounting unit 740 calculates the total bill by acquiring the dish data associated with the serving destination data from the order data storage unit 720 to achieve payment processing. The method for the payment processing performed in the accounting unit 740 is not particularly limited, and may be payment by cash, or electronic payment such as a credit card, a debit card, a prepaid card, electronic money, or QR code (registered trademark). After the accounting is completed in the accounting unit 740, the receipt output unit 790 outputs a receipt. In the receipt, the content of accounting, such as the dish data, the price of each dish, the billing amount and so on are written.

After the accounting is completed in the accounting unit 740, the clearing control unit 750 generates clearing instruction data and transmits the clearing instruction data to the serving robot 300. The clearing instruction data includes the customer seat number (serving destination data) that corresponds to the customer seat for which the accounting has been completed. The serving robot status storage unit 770 stores the status of the serving robot 300. For example, after the serving control unit 730 transmits the serving instruction data to the serving robot 300, the serving robot status storage unit 770 changes the status of the serving robot 300 to which the serving instruction data has been transmitted to “in operation”. The serving robot status storage unit 770 receives a serving completion registration request from the serving robot 300, and then changes the status of the serving robot 300 that has transmitted the serving completion registration request to “waiting”.

Note that the order management apparatus 700 includes, as components that are not shown, a processor, a memory, a storage apparatus, a communication interface unit, a communication circuit and the like. The storage apparatus stores a program in which the processing of the order management apparatus 700 is implemented. This program implements processing of the order entry unit 710, the order data storage unit 720, the serving control unit 730, the accounting unit 740, the clearing control unit 750, the serving notification unit 760, the serving robot status storage unit 770, the accounting input unit 780, and the receipt output unit 790 described above. This processor causes a program to be loaded into a memory from a storage apparatus and thus executes the program. Accordingly, the processor implements the functions of the order entry unit 710, the order data storage unit 720, the serving control unit 730, the accounting unit 740, the clearing control unit 750, the serving notification unit 760, the serving robot status storage unit 770, the accounting input unit 780, and the receipt output unit 790 described above.

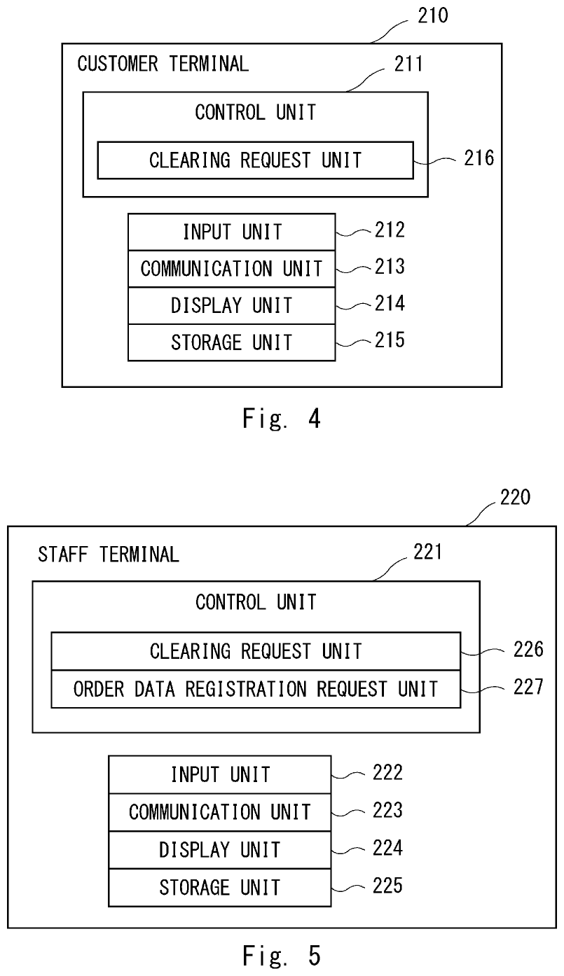

Referring next to FIG. 4, a configuration of the customer terminal 210 will be described in detail. The customer terminal 210 includes, as a hardware configuration, an input apparatus, a display apparatus, and a computer. FIG. 4 is a block diagram showing a configuration of the customer terminal 210 included in the order management system according to the second exemplary embodiment. The customer terminal 210 includes a control unit 211, an input unit 212, a communication unit 213, a display unit 214, and a storage unit 215.

The control unit 211 controls the hardware included in the customer terminal 210. The control unit 211 includes a clearing request unit 216. The clearing request unit 216 sends a clearing request to the order management apparatus 700. The clearing request includes the customer seat number (serving destination data) of the customer seat where the customer terminal 210 that has sent the request is placed. The clearing control unit 750 included in the order management apparatus 700 receives the clearing request from the customer terminal 210, and then the clearing control unit 750 transmits clearing instruction data to the serving robot 300. The clearing instruction data includes serving destination data included in the clearing request.

The input unit 212 is an input apparatus to which a customer inputs an instruction for causing the customer terminal 210 to execute various kinds of processing. The communication unit 213 is a communication interface with the network 500. The display unit 214 is a display apparatus that displays a serving notification or the like for the customer. The storage unit 215 is a storage apparatus storing a program for implementing each function of the customer terminal 210.

Referring next to FIG. 5, a configuration of the staff terminal 220 will be described in detail. The staff terminal 220 includes, as a hardware configuration, an input apparatus, a display apparatus, and a computer. FIG. 5 is a block diagram showing a configuration of the staff terminal 220 included in the order management system according to the second exemplary embodiment. The staff terminal 220 includes a control unit 221, an input unit 222, a communication unit 223, a display unit 224, and a storage unit 225.

The control unit 221 controls the hardware included in the staff terminal 220. The control unit 221 includes a clearing request unit 226 and an order data registration request unit 227. The clearing request unit 226 sends a clearing request to the order management apparatus 700. The clearing request includes the customer seat number (serving destination data) of the customer seat of the customer who wants dishes to be cleared. Upon receiving the clearing request from the staff terminal 220, the clearing control unit 750 included in the order management apparatus 700 transmits the clearing instruction data to the serving robot 300.

The order data registration request unit 227 requests the order management apparatus 700 to register order data. The order data registration request includes order data. The order data includes data of dishes a customer wants to order, and serving destination data for identifying the customer seat seated by the customer who orders the dish. Upon receiving the order data registration request, the order entry unit 710 included in the order management apparatus 700 transmits order data included in the order data registration request to the kitchen apparatus 400. Further, the order data storage unit 720 compares the serving destination data 721 stored in the order data storage unit 720 with the serving destination data included in the order data registration request, stores serving destination data 721 that matches the serving destination data in association with the dish data. Further, the order data storage unit 720 stores the cooking status of the dish data stored in association with the serving destination data 721 as “being cooked”.

The input unit 222 is an input apparatus into which a customer inputs an instruction for causing the staff terminal 220 to execute various kinds of processing. The communication unit 223 is a communication interface with the network 500. The display unit 224 is a display apparatus that displays a clearing request or the like for the floor staff member. The storage unit 225 is a storage apparatus storing a program for implementing each function of the staff terminal 220.

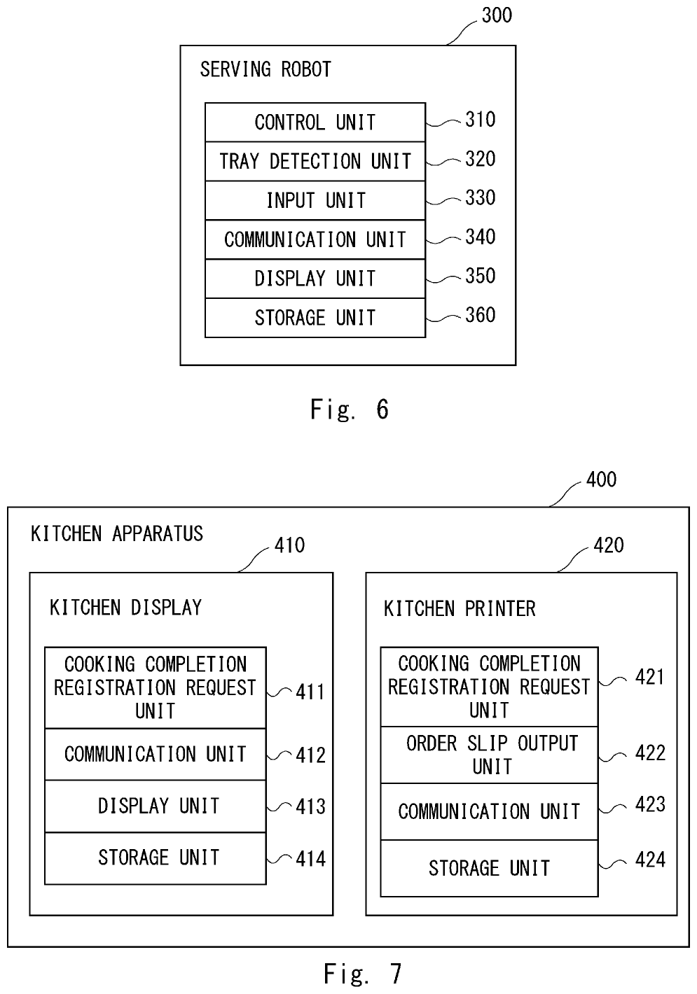

Referring next to FIG. 6, a configuration of the serving robot 300 will be described in detail. The serving robot 300 includes, as a hardware configuration, a moving apparatus, a dish placement apparatus, an input apparatus, a display apparatus, and a computer. FIG. 6 is a block diagram showing a configuration of the serving robot 300 included in the order management system according to the second exemplary embodiment. The serving robot 300 includes a control unit 310, a tray detection unit 320, an input unit 330, a communication unit 340, a display unit 350, and a storage unit 360.

The control unit 310 controls the hardware included in the serving robot 300. The control unit 310 controls, in particular, a moving apparatus included in the serving robot 300. After the control unit 310 receives serving instruction data or clearing instruction data, the control unit 310 causes the serving robot 300 to move to the customer seat based on the serving destination data included in the received data.

The dish placement apparatus included in the serving robot 300 includes a tray on which cooked dishes can be placed. The tray detection unit 320 detects a dish placed on the tray. The tray detection unit 320 is, for example, a weight sensor, and determines whether or not a dish is placed thereon by detecting the weight of objects placed on the tray. Further, the tray detection unit 320 may shoot an image inside the tray and determine whether or not dishes are placed on the tray from the shot image. When the tray detection unit 320 has detected that there is no dish placed on the tray, that is, that a customer has received the dish, the control unit 310 determines that the serving has been completed and transmits a serving completion registration request to the order management apparatus 700. The order data storage unit 720 changes the cooking status of the dish data served by the serving robot 300 that has requested serving completion registration to “serving completed”.

The input unit 330 is an input apparatus into which a cooking staff member or a floor staff member inputs an instruction for causing the serving robot 300 to execute various kinds of processing. The communication unit 340 is a communication interface with the network 500. The display unit 350 is a display apparatus that displays a serving instruction screen or the like for a customer. The storage unit 360 is a storage apparatus storing a program for implementing each function of the serving robot 300.

Note that a plurality of serving robots 300 may be installed in an eating place. In a case in which a plurality of serving robots 300 are installed, serving robot data is attached to each of the serving robots 300. The serving robot data is data for identifying each of the serving robots 300. The serving robot data is, for example, a number attached to each serving robot 300. Further, the serving robot 300 may include a plurality of trays. In a case in which the serving robot 300 includes a plurality of trays, each tray includes a tray detection unit 320. Further, in the case in which the serving robot 300 includes a plurality of trays, tray data is attached to each tray. The tray data is data for identifying each tray. The tray data is a name indicating, for example, a positional relation of each tray in the serving robot 300. Specifically, the tray data is, for example, an upper stage, a middle stage, or a lower stage.

Referring next to FIG. 7, a configuration of the kitchen apparatus 400 will be described in detail. FIG. 7 is a block diagram showing a configuration of the kitchen apparatus 400 included in the order management system according to the second exemplary embodiment. The kitchen apparatus 400 includes a kitchen display 410 and a kitchen printer 420. The kitchen display 410 includes a cooking completion registration request unit 411, a communication unit 412, a display unit 413, and a storage unit 414. The kitchen printer 420 includes a cooking completion registration request unit 421, an order slip output unit 422, a communication unit 423, and a storage unit 424. The kitchen display 410 includes, as a hardware configuration, an input apparatus, a display apparatus, and a computer. The kitchen printer 420 includes, as a hardware configuration, an input apparatus, an order slip output apparatus, and a computer.

The kitchen display 410, which is an apparatus that displays ordered dishes for a cooking staff member and into which the cooking staff member inputs completion of cooking, may be, for example, a Dish-Up display. The cooking completion registration request unit 411 is an input apparatus into which the cooking staff member inputs information indicating completion of cooking. The cooking completion registration request unit 411 transmits a cooking completion registration request to the order management apparatus 700 based on the information indicating the completion of cooking input by the cooking staff member. The cooking completion registration request includes dish data of a dish that has already been cooked and serving destination data of this dish. After the order data storage unit 720 receives the cooking completion registration request, the order data storage unit 720 changes the cooking status of the dish data included in the cooking completion registration request to “cooking completed”. The communication unit 412 is a communication interface with the network 500. The display unit 413 is a display apparatus for displaying ordered dishes for a cooking staff member. The storage unit 414 is a storage apparatus storing a program for implementing each function of the kitchen display 410.

The kitchen printer 420 is an apparatus that outputs an order slip of the ordered dishes and into which a cooking staff member inputs completion of cooking. The cooking completion registration request unit 421 is an input apparatus into which the cooking staff member inputs completion of cooking. Since the cooking completion registration request unit 421 includes a function similar to that of the cooking completion registration request unit 411, the descriptions thereof will be omitted. The order slip output unit 422 is an order slip output apparatus that prints the order slip of the ordered dishes. The dish data, the serving destination data and so on are written in the order slip. The communication unit 423 is a communication interface with the network 500. The storage unit 424 is a storage apparatus storing a program for implementing each function of the kitchen printer 420.

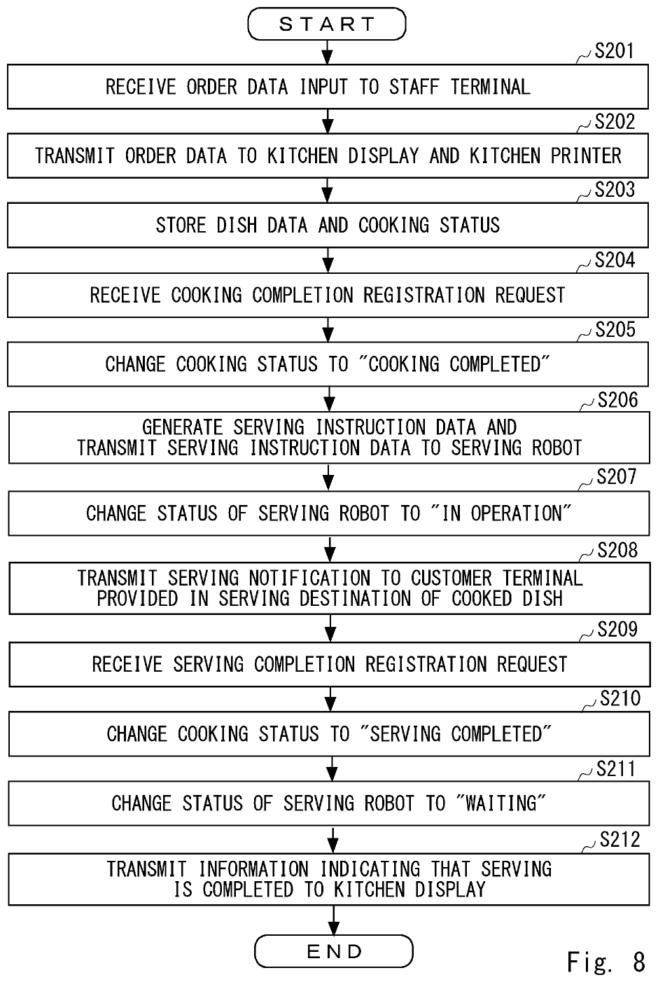

Referring next to FIG. 8, one example of an operation of the order management apparatus 700 from the order of dishes to the completion of serving will be described. FIG. 8 is a flowchart showing an operation example of the order management apparatus 700 from the order of dishes to the completion of serving in an order management method according to the second exemplary embodiment.

In the order management method according to the second exemplary embodiment, a floor staff member inputs order data from the staff terminal 220. The order entry unit 710 receives the order data from the staff terminal 220 (Step S201), and then the order entry unit 710 transmits the received order data to the kitchen display 410 and the kitchen printer 420 (Step S202). Next, the order data storage unit 720 changes the cooking status of the dish data included in the received order data to “being cooked”, and stores the dish data and the cooking status in association with the serving destination data (Step S203). Step S203 may be performed before Step S202 or may be performed in parallel to Step S202.

After the order data storage unit 720 receives a cooking completion registration request from the kitchen display 410 or the kitchen printer 420 (Step S204), the order data storage unit 720 changes the cooking status of the dish data included in the cooking completion registration request to “cooking completed” (Step S205). Further, the serving control unit 730 generates serving instruction data including serving destination data included in the cooking completion registration request and transmits the generated serving instruction data to the serving robot 300 (Step S206). Further, the serving robot status storage unit 770 changes the status of the serving robot 300 to which the serving instruction data has been transmitted to “in operation” (Step S207). Further, the serving notification unit 760 transmits a serving notification to the customer terminal 210 provided in the customer seat corresponding to the serving destination data included in the cooking completion registration request (Step S208). Note that the order in which Steps S205, S206, S207, and S208 are performed is not particularly limited and some of these steps may be performed in parallel to each other.

Upon receiving a serving completion registration request from the serving robot 300 (Step S209), the order data storage unit 720 changes the cooking status of the dish data of the dish served by the serving robot 300 to “serving completed” (Step S210). Further, the serving robot status storage unit 770 changes the status of the serving robot 300 that has transmitted the serving completion registration request to “waiting” (Step S211). Further, the serving control unit 730 transmits information indicating that serving of the dish has been completed to the kitchen display 410 (Step S212). Note that the order in which Steps S210, S211, and S212 are performed is not particularly limited and some of these steps may be performed in parallel to each other.

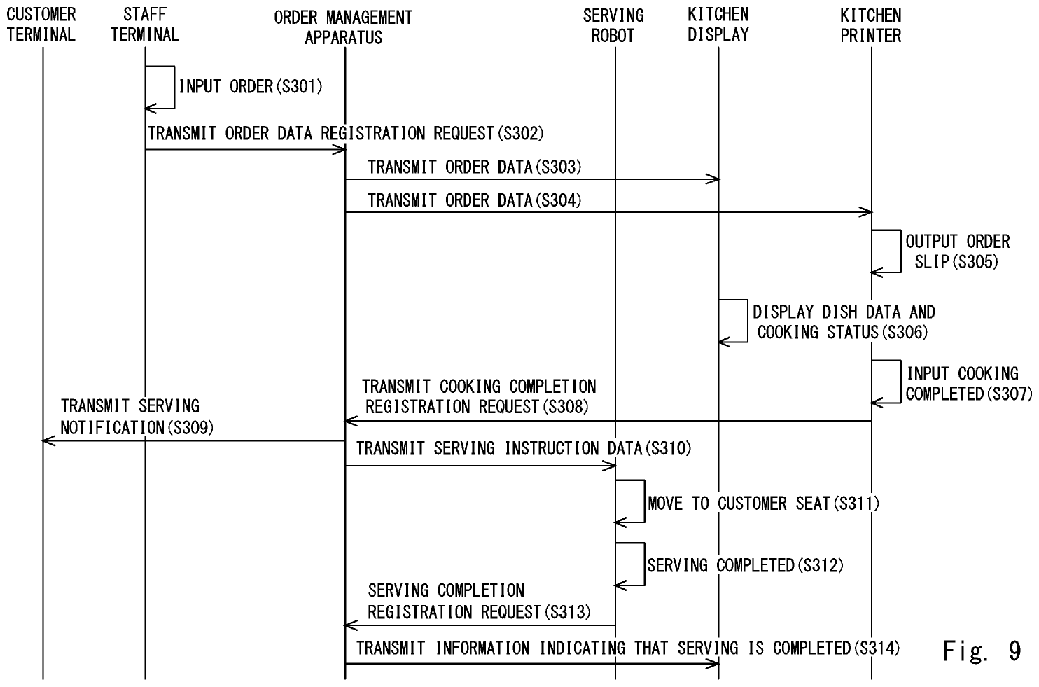

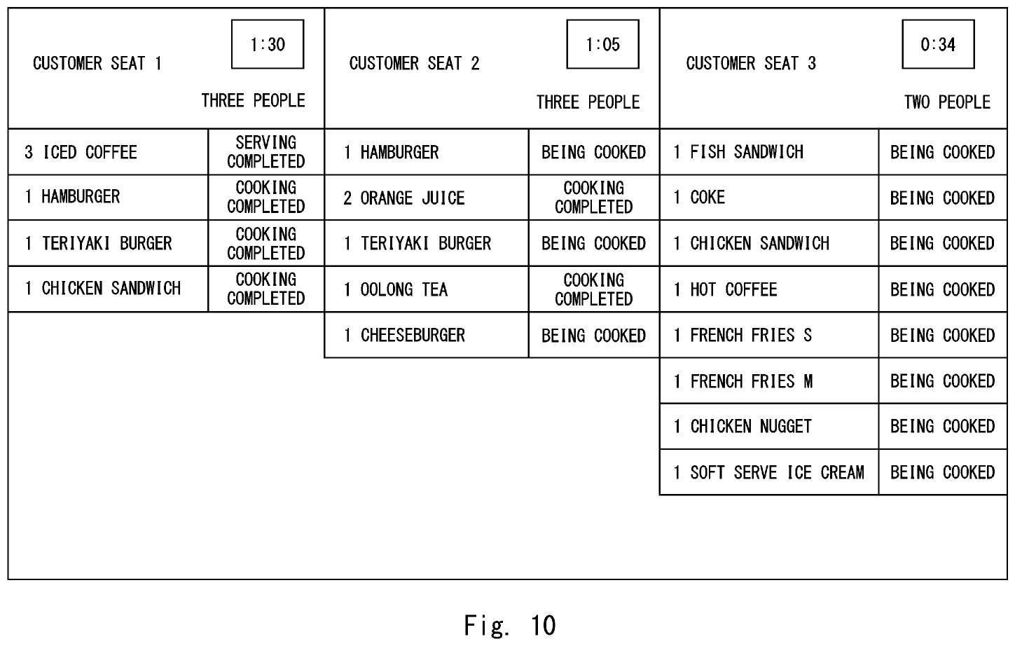

Referring next to FIGS. 9-12, one example of an operation of the order management system 800 from the order of dishes to the completion of serving will be described. FIG. 9 is a sequence chart showing one example of a flow of processing from the order of dishes to the completion of serving in the order management method according to the second exemplary embodiment.

A floor staff member inputs dish data of the dish that a customer wants to order and the customer seat number (serving destination data) of the customer seat seated by the customer into the input unit 222 included in the staff terminal 220 (Step S301). After the dish data and the serving destination data are input to the input unit 222, the order data registration request unit 227 included in the staff terminal 220 transmits an order data registration request to the order management apparatus 700 (Step S302). Note that the order data registration request includes dish data and serving destination data.

Upon receiving the order data registration request, the order management apparatus 700 transmits the order data included in the order data registration request to the kitchen display 410 and the kitchen printer 420 (Steps S303 and S304). Step S304 may be performed before Step S303 or may be performed in parallel to Step S303.

Upon receiving the order data, the order slip output unit 422 included in the kitchen printer 420 outputs the order slip in which the order data is written (Step S305). Upon receiving the order data, the display unit 413 included in the kitchen display 410 displays the dish data and the cooking status (Step S306). A cooking staff member sees the displayed dish data and cooks the dish. FIG. 10 is a diagram showing one example of the order data display screen displayed on the kitchen display 410. The display unit 413 displays, for example, an order data display screen as shown in FIG. 10. The order data may include, besides the dish data and the serving destination data, data of the number of customers who are seated in the customer seats, a time when an order has been input, and so on. In the example shown in FIG. 10, dishes ordered in each customer seat and the cooking status of each dish are displayed in association with each other, and the number of customers who are seated in each customer seat and an elapsed time since the time when the order has been made are displayed. By displaying the elapsed time since the time when the order has been made on the order data display screen, a cooking staff member is able to know a customer seat to which dishes have not been served and where the elapsed time is long.

Referring once again to FIG. 9, the explanation will be continued.

After a cooking staff member finishes cooking a dish, he/she places the cooked dish on a tray in the serving robot 300 together with the order slip output in Step S305. Then, the cooking staff member inputs information indicating that cooking of the dish has been completed into the cooking completion registration request unit 421 included in the kitchen printer 420 (Step S307). In a case in which a plurality of serving robots 300 are installed in the eating place, the cooking staff member inputs, when he/she inputs information on the cooked dish into the cooking completion registration request unit 421, the serving robot number of the serving robot 300 in which this dish is placed. Further, in a case in which a plurality of trays are provided in the serving robot 300, the cooking staff member inputs, when he/she inputs information on the cooked dish into the cooking completion registration request unit 421, tray data of the tray on which this dish is placed.

The cooking completion registration request unit 421 transmits a cooking completion registration request to the order management apparatus 700 based on a content input by the cooking staff member (Step S308). The cooking completion registration request may at least include the dish data of the cooked dish and the serving destination data, and further include serving robot data of the serving robot 300 in which this dish is placed and tray data.

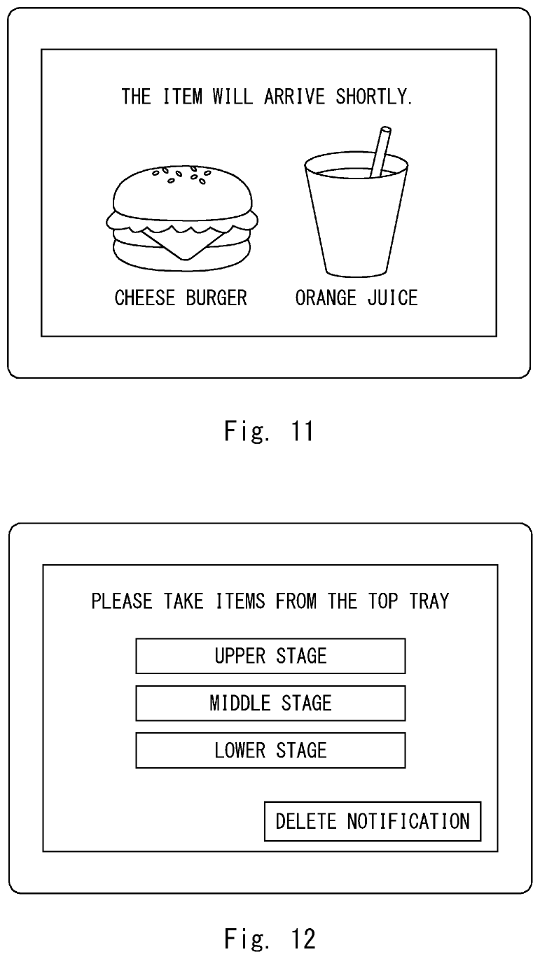

Upon receiving the cooking completion registration request, the serving notification unit 760 included in the order management apparatus 700 transmits a serving notification to the customer terminal 210 provided in the customer seat corresponding to the serving destination data included in the cooking completion registration request (Step S309). The serving notification is a notification including a message for notifying a customer of information indicating that the cooked dish will be served shortly. The serving notification may further include the dish data of the cooked dish, the photo of this dish and so on. FIG. 11 is a diagram showing one example of the serving notification screen displayed on the customer terminal 210. As shown in FIG. 11, by displaying the serving notification screen including the name of the dish to be served and the photo of the dish to be served on the customer terminal 210, a customer is able to know that the dish that will be served shortly.

FIG. 12 is a diagram showing one example of a serving instruction screen displayed on the customer terminal 210. After the customer terminal 210 displays the serving notification screen as shown in FIG. 11, the customer terminal 210 may display the serving instruction screen as shown in FIG. 12. The serving instruction screen is a screen including a message for letting a customer receive a dish. In a case in which the serving robot 300 includes a plurality of trays, the customer terminal 210 preferably displays a serving instruction screen including an instruction indicating from which tray the customer is supposed to receive the dish, as shown in FIG. 12.

In a case in which the serving robot 300 includes a plurality of trays, in Step S309, the serving notification unit 760 transmits a serving notification including tray data of the tray on which the dish is placed to the customer terminal 210. The customer terminal 210 displays a serving instruction screen including an instruction indicating from which tray the customer is supposed to receive the dish based on the received serving notification. The customer is able to know on which tray the dish he/she has ordered is placed by checking the serving instruction screen including the instruction indicating from which tray the customer is supposed to receive the dish. Further, as shown in FIG. 12, the serving notification screen and the serving instruction screen may display a “delete notification” button. When a notification is not required, the customer may delete the serving notification screen and the serving instruction screen by operating the “delete notification” button.

Referring once again to FIG. 9, the explanation will be continued.

Upon receiving the cooking completion registration request, the serving control unit 730 included in the order management apparatus 700 generates serving instruction data including serving destination data included in the cooking completion registration request and transmits the generated serving instruction data to the serving robot 300 (Step S310). In a case in which a plurality of serving robots 300 are installed in the eating place, the cooking completion registration request includes serving robot data of the serving robot 300 in which the cooked dish is placed. The serving control unit 730 then transmits the serving instruction data to the serving robot 300 corresponding to the serving robot data included in the cooking completion registration request.

Upon receiving the serving instruction data, the serving robot 300 moves to the customer seat that corresponds to the serving destination data included in the serving instruction data (Step S311). The customer receives the dish according to the above-described serving instruction screen. After the tray detection unit 320 detects, from a change in the weight of the objects placed on the tray, that the customer has received the dish, the control unit 310 determines that the serving has been completed (Step S312) and transmits a serving completion registration request to the order management apparatus 700 (Step S313). In a case in which a plurality of serving robots 300 are installed in the eating place, the control unit 310 transmits a serving completion registration request including the serving robot data corresponding to itself to the order management apparatus 700. Upon receiving the serving completion registration request, the order entry unit 710 transmits information indicating that the serving to the customer seat has been completed to the kitchen display 410 (Step S314).

While a case in which a cooking staff member inputs cooking completion registration from the kitchen printer 420 has been described in FIG. 9, the cooking staff member may input the cooking completion registration from the kitchen display 410. Further, while a case in which the serving robot 300 is moved based on the serving robot number that a cooking staff member has input to the kitchen printer 420 has been described in FIG. 9, the serving robot 300 may move to a customer seat based on the serving destination data input to this serving robot 300. In this case, the cooking staff member inputs serving destination data of the dish placed in the serving robot 300 from the input unit 330 included in the serving robot 300. The serving robot 300 moves to the customer seat based on the input serving destination data.

Further, in a case in which the tray detection unit 320 included in the serving robot 300 shoots an image inside the tray and determines whether or not a dish is placed thereon by image recognition, the serving robot 300 may acquire the serving destination data by image recognition. For example, the tray detection unit 320 may shoot an image of the dishes placed in the tray and an image of the order slip and acquire the serving destination data printed on the order slip by image recognition. When the serving robot 300 acquires the serving destination data by image recognition, the cooking staff member does not need to input serving destination data in order to move the serving robot 300 to the customer seat.

Further, the tray detection unit 320 may shoot an image of the dishes placed in the tray and an image of the order slip and acquire dish data printed on the order slip by image recognition. In this case, the serving robot 300 may transmit the dish data and the serving destination data acquired by the tray detection unit 320 to the order management apparatus 700 as a cooking completion registration request. When the serving robot 300 acquires the dish data and the serving destination data by image recognition and transmits the cooking completion registration request, a cooking staff member does not need to manually input cooking completion registration.

Further, while the case in which the serving instruction screen is displayed on the customer terminal 210 has been described with reference to FIG. 9, the serving instruction screen as shown in FIG. 12 may be displayed on the display unit 350 included in the serving robot 300. The serving robot 300 arrives at a customer seat, and then a serving instruction screen is displayed on the display unit 350. The serving instruction screen is a screen including a message for letting the customer receive the dish. In a case in which the serving robot 300 includes a plurality of trays, the display unit 350 preferably displays a serving instruction screen including an instruction indicating from which tray the customer is supposed to receive the dish, as shown in FIG. 12.

Further, when a dish is left in a tray for a predetermined period of time or longer, the tray detection unit 320 may notify the order management apparatus 700 that there is an abnormality. When the order management apparatus 700 is notified of the abnormality, the order management apparatus 700 transmits information indicating that it has been notified of the abnormality to the staff terminal 220. The order management apparatus 700 transmits information indicating that the abnormality has been detected to the staff terminal 220, whereby a floor staff member is able to know that the serving of the dish has not yet been completed.

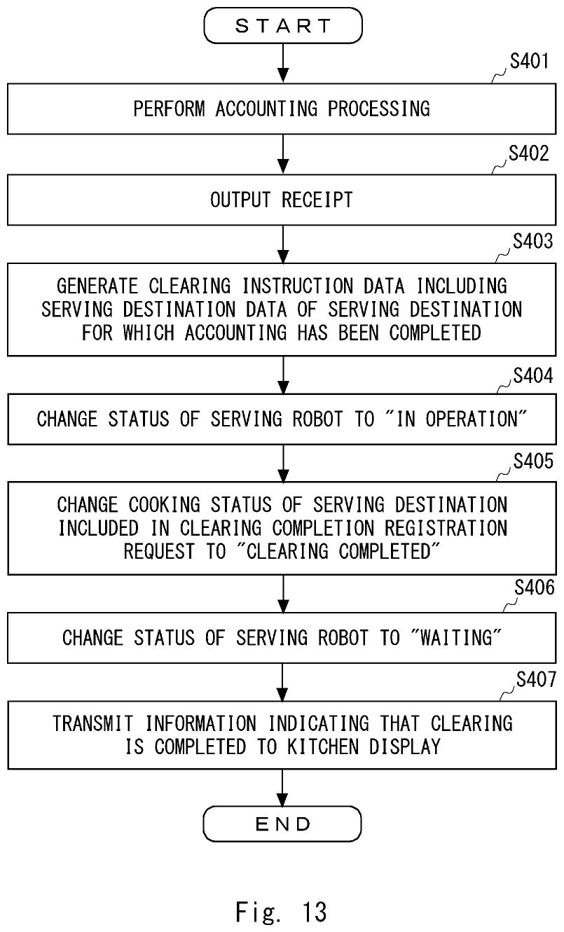

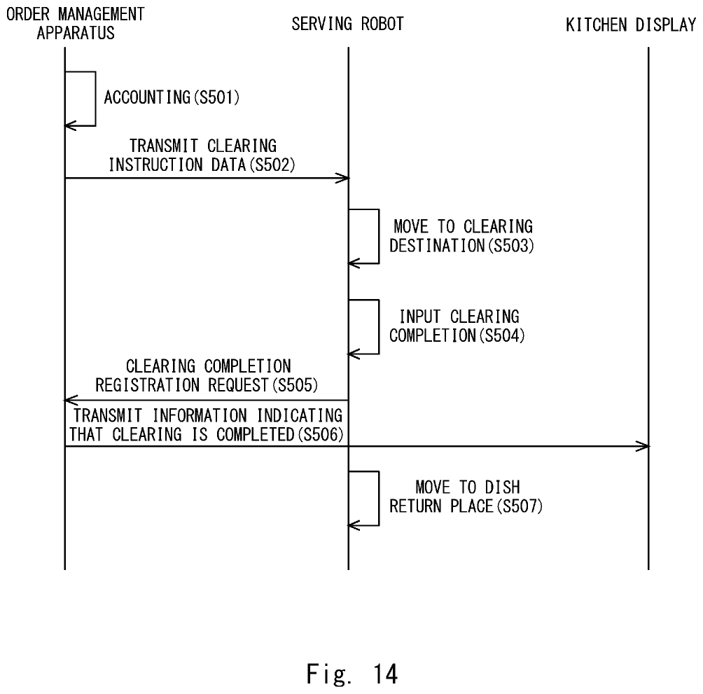

Referring next to FIG. 13, one example of the operation of the order management apparatus 700 from the accounting to the completion of clearing will be described. FIG. 13 is a flowchart showing an operation example of the order management apparatus from the accounting to the completion of clearing in the order management method according to the second exemplary embodiment.

In the order management method according to the second exemplary embodiment, after a customer finishes eating, a floor staff member operates the order management apparatus 700 and performs accounting. After the customer finishes eating, he/she tells the floor staff member that he/she wants to pay the bill. The floor staff member inputs the customer seat number (serving destination data) into the accounting input unit 780, and then the accounting unit 740 performs accounting based on the input serving destination data (Step S401). After the accounting is completed in the accounting unit 740, the receipt output unit 790 outputs a receipt (Step S402). Further, after the accounting is completed in the accounting unit 740, the clearing control unit 750 generates clearing instruction data including serving destination data of the serving destination for which accounting has been completed and transmits the generated clearing instruction data to the serving robot 300 (Step S403). Further, after the accounting is completed in the accounting unit 740, the serving robot status storage unit 770 changes the status of the serving robot 300 to which the clearing instruction data has been transmitted to “in operation” (Step S404). Note that the order in which Steps S402, S403, and S404 are performed is not particularly limited and some of these steps may be performed in parallel to each other.

Upon receiving the clearing completion registration request from the serving robot 300, the order data storage unit 720 changes the cooking status of the dish data ordered in the customer seat from which the serving robot 300 has cleared the dishes to “clearing completed” (Step S405). Further, upon receiving the clearing completion registration request from the serving robot 300, the serving robot status storage unit 770 changes the status of the serving robot 300 that has transmitted the clearing completion registration request to “waiting” (Step S406). Further, the order entry unit 710 transmits information indicating that the clearing in the customer seat has been completed to the kitchen display 410 (Step S407). Note that the order in which Steps S405, S406, and S407 are performed is not particularly limited and some of these steps may be performed in parallel to each other.

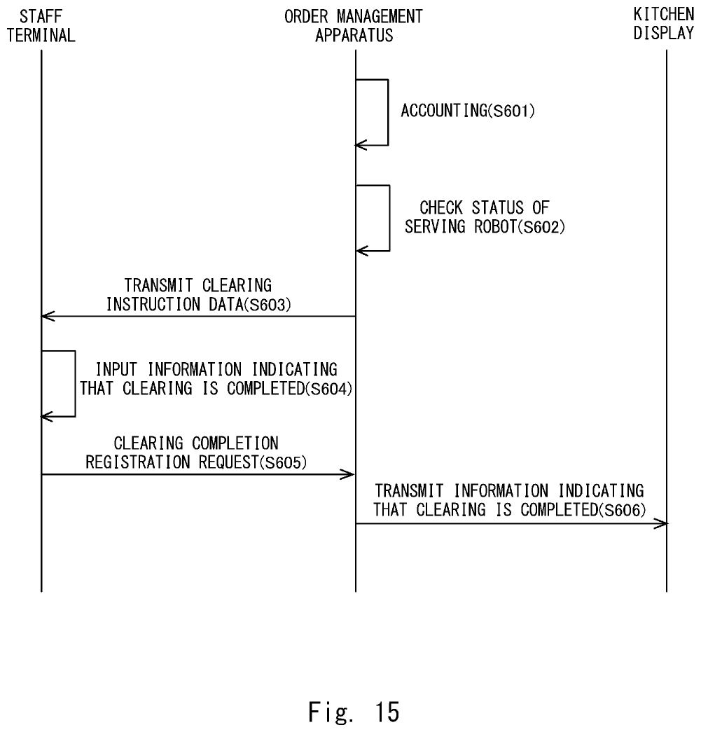

Referring next to FIG. 14, one example of an operation of the order management system 800 from the accounting to the completion of clearing will be described. FIG. 14 is a sequence chart showing one example of a flow of processing from the accounting to the completion of clearing in the order management method according to the second exemplary embodiment. Note that the sequence chart shown in FIG. 14 is an operation example of the order management system 800 in a case in which the status of the serving robot 300 is “waiting” when the clearing is instructed.

After a floor staff member inputs the customer seat number (serving destination data) of the customer seat seated by the customer who wants to pay the bill into the accounting input unit 780 included in the order management apparatus 700, the accounting unit 740 performs accounting based on the serving destination data (Step S501). After the accounting is completed, the clearing control unit 750 transmits clearing instruction data including serving destination data of the serving destination for which accounting has been completed to the serving robot 300 (Step S502). The serving robot 300 moves to the customer seat corresponding to the serving destination data included in the clearing instruction data, that is, a clearing destination (Step S503). The floor staff member places the dishes and the like on a tray included in the serving robot 300 in the clearing destination and inputs information indicating that clearing has been completed from the input unit 330 (Step S504). After the completion of clearing is input, the control unit 310 transmits a clearing completion registration request to the order management apparatus 700 (Step S505).

After the order management apparatus 700 receives the clearing completion registration request, the order management apparatus 700 transmits information indicating that the clearing in the customer seat has been completed to the kitchen display 410 (Step S506). When the information indicating that clearing has been completed is input, the serving robot 300 moves to a dish return place (Step S507). Note that Step S507 may be performed before Step S505 or may be performed in parallel to Step S505.

In a case in which the serving robot 300 is in operation when the clearing is instructed, a clearing instruction may be sent to the floor staff member, not to the serving robot 300. Referring now to FIG. 15, an operation of the order management system 800 in a case in which the serving robot 300 is “in operation” when the clearing is instructed will be described. FIG. 15 is a sequence chart showing one example of a flow of processing from the accounting to the completion of clearing in a case in which the serving robot is in operation in the order management method according to the second exemplary embodiment.

When accounting (Step S601) is completed in the accounting unit 740, the clearing control unit 750 refers to the serving robot status storage unit 770 and checks the status of the serving robot 300 (Step S602). When the status of the serving robot 300 is in operation, the clearing control unit 750 transmits clearing instruction data to the staff terminal 220 (Step S603). The floor staff member clears the dishes in the customer seat in accordance with the clearing instruction. After the floor staff member clears the dishes, the floor staff member inputs information indicating that clearing has been completed from the input unit 222 included in the staff terminal 220 (Step S604). After the information indicating that clearing has been completed is input, the control unit 221 transmits a clearing completion registration request to the order management apparatus 700 (Step S605). After the order management apparatus 700 receives the clearing completion registration request, the order management apparatus 700 transmits information indicating that the clearing in the customer seat has been completed to the kitchen display 410 (Step S506).

As described above, in the order management method according to the second exemplary embodiment, the order entry system and the accounting system are associated with each other, and a clearing instruction can be automatically sent to the serving robot 300 after accounting is completed. It is therefore possible to improve the entire operation in the floor 10.

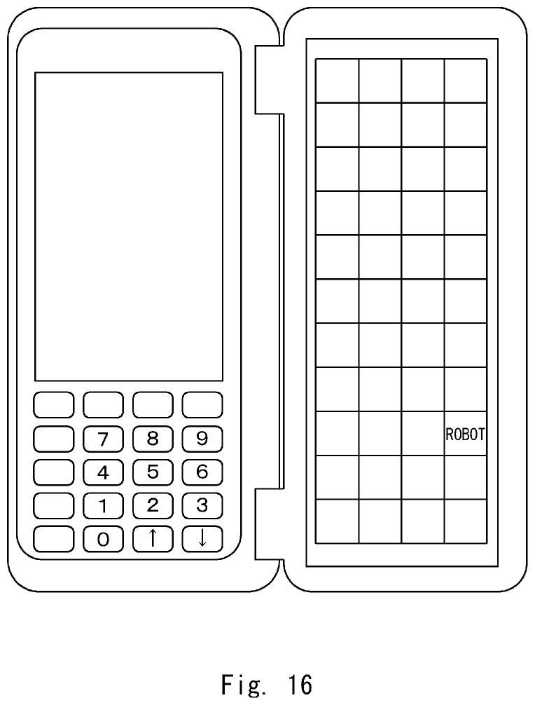

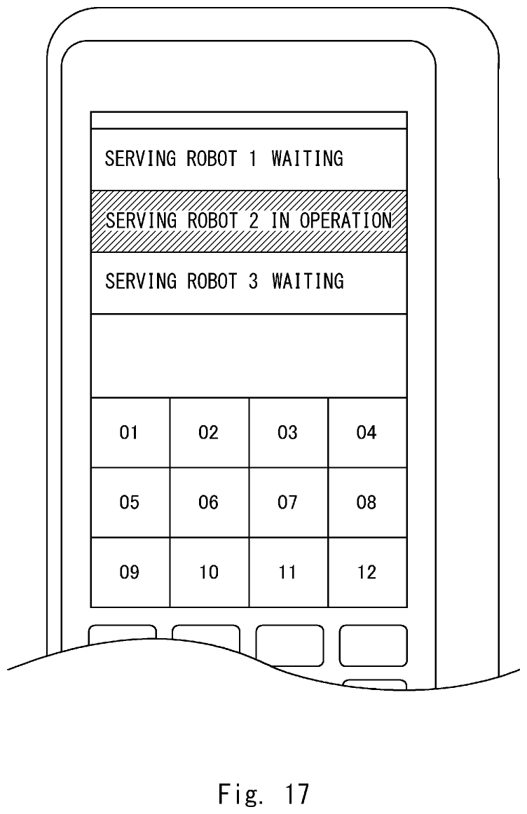

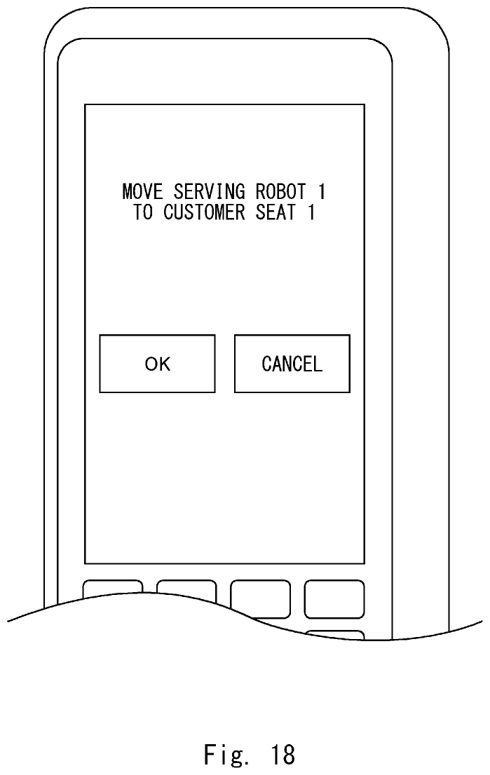

There is a case in which it is desirable to clear dishes in the middle of a meal in the customer seat, such as a case in which the customer additionally orders dessert. In the order management system according to the second exemplary embodiment, it is possible to request to clear the dishes in the middle of a meal from the customer terminal 210 or the staff terminal 220. First, with reference to FIGS. 16-18, a case in which it is requested to clear the dishes from the staff terminal 220 will be described. FIG. 16 is a diagram showing one example of a staff terminal in the order management system according to the second exemplary embodiment. FIG. 17 is one example of a serving robot selection screen in the order management system according to the second exemplary embodiment. FIG. 18 is an example of a serving robot moving request screen in the order management system according to the second exemplary embodiment. It is assumed, in the examples described with reference to FIGS. 16-18, that a plurality of serving robots 300 are installed in the eating place.

FIG. 16 is one example of a handy terminal used as the staff terminal 220. As shown in FIG. 16, the staff terminal 220 includes a “robot” button. A floor staff member selects the “robot” button, and then a serving robot selection screen as shown in FIG. 17 is displayed on the display unit 224 of the staff terminal 220. The serving robot selection screen is a screen capable of selecting a serving robot 300 to which a clearing instruction can be sent. In the example shown in FIG. 17, the status of each serving robot 300 is displayed on the serving robot selection screen, and the floor staff member is able to select only a serving robot 300 whose status is “waiting”.

After a floor staff member selects the serving robot 300 and the customer seat number on the serving robot selection screen, a serving robot moving request screen as shown in FIG. 18 is displayed on the display unit 224 of the staff terminal 220. The serving robot moving request screen is a screen for checking which serving robot 300 should be caused to move to which customer seat and sending a moving request. The floor staff member checks the content of the moving request in the serving robot moving request screen as shown in FIG. 18 and selects the “OK” button. After the floor staff member selects the “OK” button on the serving robot moving request screen, the clearing request unit 226 included in the staff terminal 220 transmits a clearing request to the order management apparatus 700.

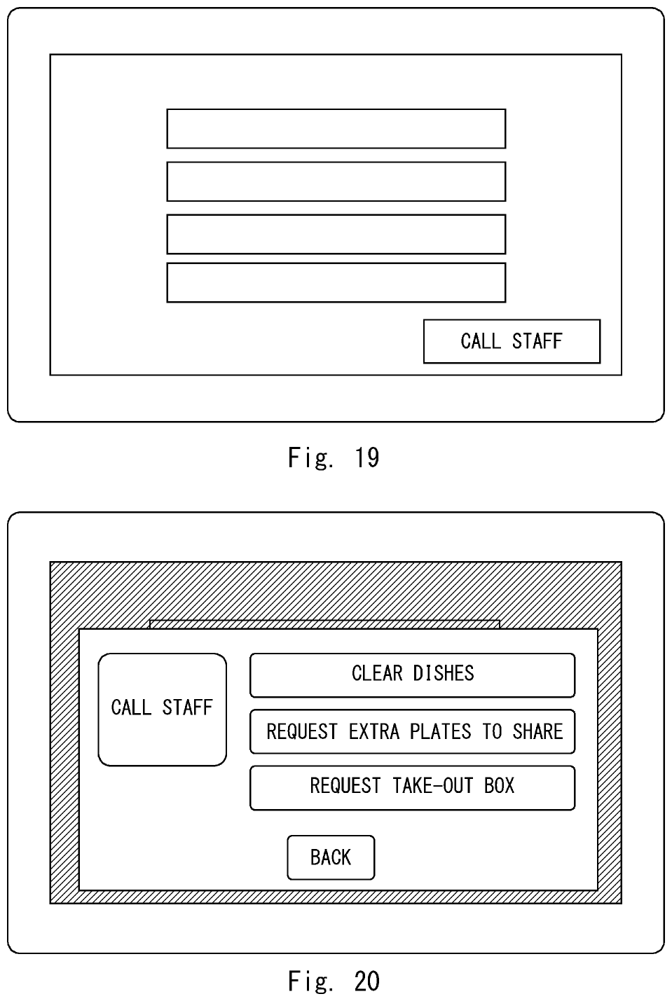

Referring next to FIGS. 19 and 20, a case in which a customer requests the dishes to be cleared through the customer terminal 210 will be described. FIG. 19 is one example of a display screen of the customer terminal in the order management system according to the second exemplary embodiment. FIG. 20 is one example of a staff calling screen in the order management system according to the second exemplary embodiment.

FIG. 19 is one example of a display screen displayed on the display unit 214 of the customer terminal 210. As shown in FIG. 19, the display screen of the customer terminal 210 includes a “call staff” button. A customer selects the “call staff” button, and then a staff calling screen as shown in FIG. 20 is displayed on the display unit 214 of the customer terminal 210. The staff calling screen is a screen for calling a staff member in response to the customer's request. When the customer wants the dishes to be cleared, the customer selects a “clear dishes” button displayed on the staff calling screen. The customer selects the “clear dishes” button, and then the clearing request unit 216 included in the customer terminal 210 transmits a clearing request to the order management apparatus 700.

Further, in the order management system according to the second exemplary embodiment, the serving robot 300 may carry extra plates to share, a take-out box, and so on. For example, in the example shown in FIG. 20, a “require extra plates to share” button and a “require take-out box” button are displayed on the staff calling screen. For example, a customer selects the “require extra plates to share” button, and then the control unit 211 transmits an extra-plates-to-share request to the order management apparatus 700. The extra-plates-to-share request includes the customer seat number (serving destination data) of the customer seat seated by the customer who requires extra plates to share. Upon receiving the extra-plates-to-share request, the order management apparatus 700 transmits this request to the kitchen display 410 and the kitchen printer 420.

Upon receiving the extra-plates-to-share request, the kitchen display 410 displays information indicating that a customer is requiring extra plates to share and the customer seat number of the customer seat seated by the customer who requires extra plates to share. The kitchen printer 420 outputs an order slip in which an extra-plates-to-share request is written. The cooking staff member prepares extra plates to share in accordance with the extra-plates-to-share request displayed on the kitchen display 410 and places the extra plates to share in the serving robot 300 together with the output order slip. Then the cooking staff member inputs information indicating that extra plates to share have already been placed into the kitchen display 410 or the kitchen printer 420. After the cooking staff member inputs information indicating that extra plates to share have already been placed, the kitchen display 410 or the kitchen printer 420 transmits information indicating that extra plates to share have already been placed to the order management apparatus 700.

Upon receiving the information indicating that extra plates to share have already been placed, the serving control unit 730 included in the order management apparatus 700 generates serving instruction data and transmits the generated serving instruction data to the serving robot 300. The serving robot 300 moves to the customer seat based on the serving instruction data. In this manner, the serving robot 300 is able to carry extra plates to share to the customer seat in accordance with the request from the customer. Since the serving robot 300 is able to carry a take-out box by an operation similar to that performed when extra plates to share are carried, the description of a case in which a customer has requested a take-out box will be omitted.

### Third Exemplary Embodiment

A third exemplary embodiment is a modified example of the above-described second exemplary embodiment. In the third exemplary embodiment, an order of dishes and accounting are performed from a customer terminal. In the following, an order management system according to the third exemplary embodiment will be described, but the descriptions overlapping to those in the second exemplary embodiment and the like will be omitted as appropriate.

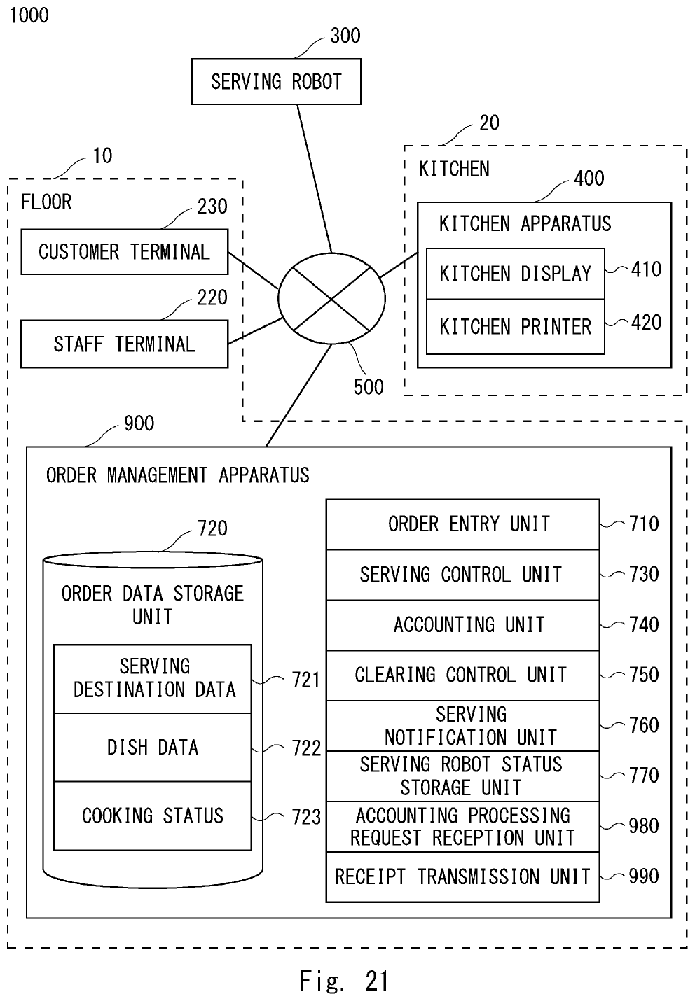

FIG. 21 is a block diagram showing a configuration of an order management system according to the third exemplary embodiment. As shown in FIG. 21, an order management system 1000 includes an order management apparatus 900 instead of the order management apparatus 700 shown in FIG. 3 and includes a customer terminal 230 instead of the customer terminal 210 shown in FIG. 3. Note that the customer terminal 230 is one example of the aforementioned order input terminal.

The order management apparatus 900 includes an accounting request reception unit 980 instead of the accounting input unit 780 shown in FIG. 3. In the third exemplary embodiment, after a customer finishes eating, he/she operates the customer terminal 230 to pay the bill. After the accounting request reception unit 980 receives an accounting request from the customer terminal 230, the accounting request reception unit 980 requests the accounting unit 740 to perform accounting. The order management apparatus 900 includes a receipt transmission unit 990 instead of the receipt output unit 790 shown in FIG. 3. After the accounting is completed in the accounting unit 740, the receipt transmission unit 990 transmits a receipt to the customer terminal 230.

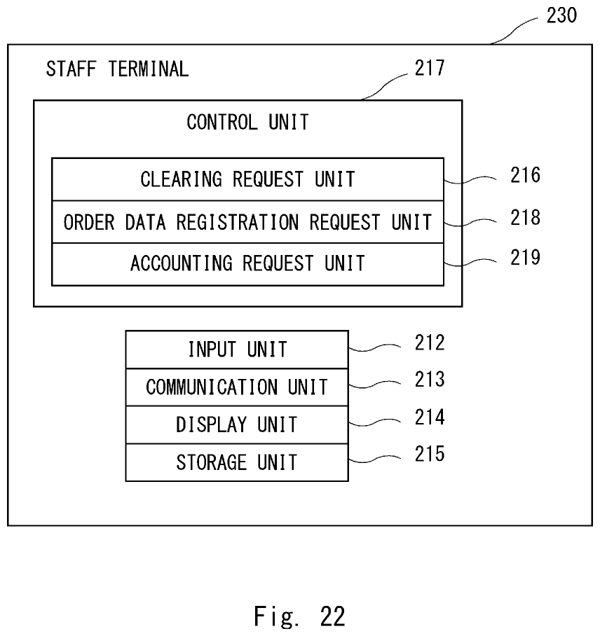

FIG. 22 is a block diagram showing a configuration of a customer terminal included in the order management system according to the third exemplary embodiment. The customer terminal 230 include a control unit 217 instead of the control unit 211 shown in FIG. 4. The control unit 217 includes, besides the clearing request unit 216 shown in FIG. 4, an order data registration request unit 218 and an accounting request unit 219. The order data registration request unit 218 transmits an order data registration request to the order management apparatus 700. The accounting request unit 219 transmits an accounting request to the order management apparatus 700. The accounting request includes the customer seat number (serving destination data) of the customer seat seated by the customer who wants to pay the bill. After the accounting request reception unit 980 included in the order management apparatus 900 receives the accounting request from the customer terminal 230, the accounting request reception unit 980 requests the accounting unit 740 to perform accounting for the customer seat corresponding to the serving destination data included in the accounting request.

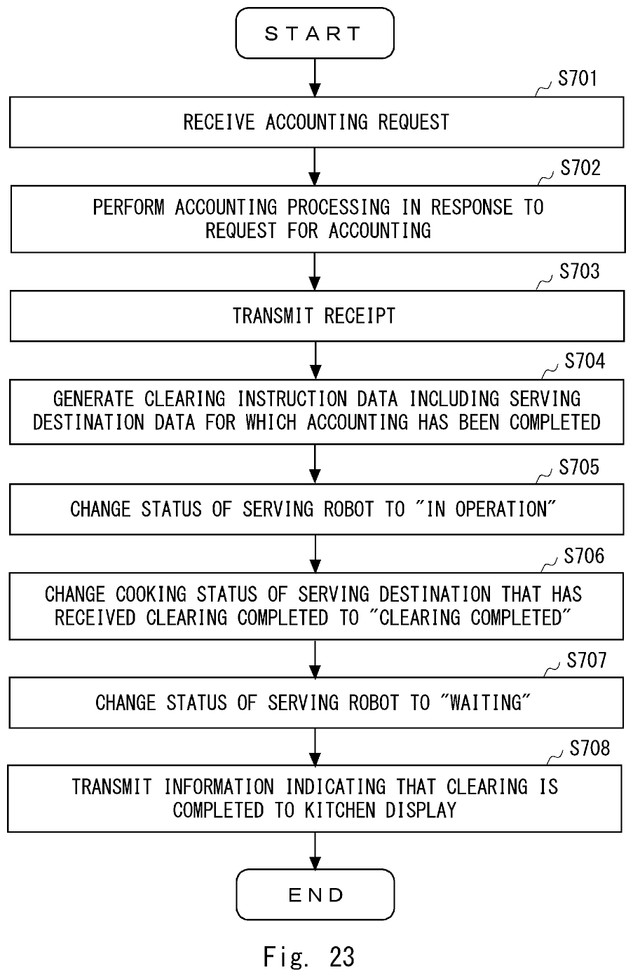

Referring next to FIG. 23, one example of an operation of the order management apparatus 900 from the accounting to the completion of clearing will be described. FIG. 23 is a flowchart showing an operation example of the order management apparatus from the accounting to the completion of clearing in an order management method according to the third exemplary embodiment.

The accounting request reception unit 980 receives an accounting request from the customer terminal 230 (Step S701), and then the accounting request reception unit 980 requests the accounting unit 740 to perform accounting for the customer seat corresponding to the serving destination data included in the accounting request. The accounting unit 740 performs accounting based on serving destination data included in the accounting request (Step S702). After the accounting is completed in the accounting unit 740, the receipt transmission unit 990 transmits a receipt to the customer terminal 230 (Step S703). Further, after the accounting is completed in the accounting unit 740, the clearing control unit 750 generates clearing instruction data including serving destination data of the serving destination for which accounting has been completed and transmits the clearing instruction data to the serving robot 300 (Step S704).

Further, after the accounting is completed in the accounting unit 740, the serving robot status storage unit 770 changes the status of the serving robot 300 to which the clearing instruction data has been transmitted to “in operation” (Step S705). Note that the order in which Steps S703, S704, and S705 are performed is not particularly limited and some of these steps may be performed in parallel to each other. Since Steps S706-S708 are similar to the aforementioned Steps S405-S407, the descriptions thereof will be omitted.

Note that the order management system according to the third exemplary embodiment may request to clear the dishes from the customer terminal 230 or the staff terminal 220. For example, a customer may select a “clear dishes” button displayed on the display unit 214 of the customer terminal 230 before accounting. After the customer selects the “clear dishes” button, the clearing request unit 216 included in the customer terminal 230 transmits a clearing request to the order management apparatus 900. After the clearing control unit 750 included in the order management apparatus 900 receives the clearing request from the customer terminal 230 or the staff terminal 220, the clearing control unit 750 transmits clearing instruction data to the serving robot 300. The serving robot 300 moves to the customer seat in accordance with the clearing instruction data.

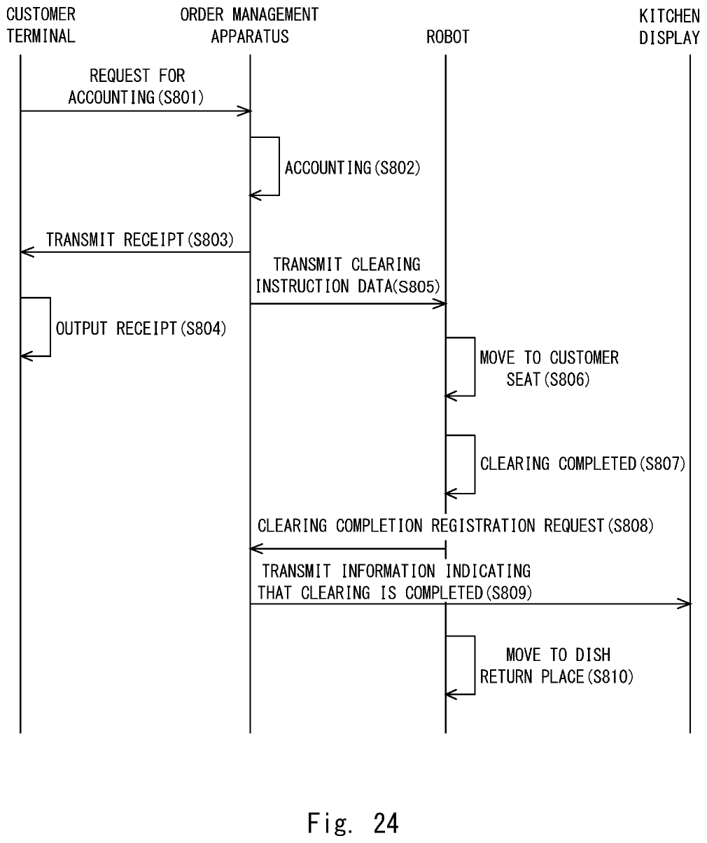

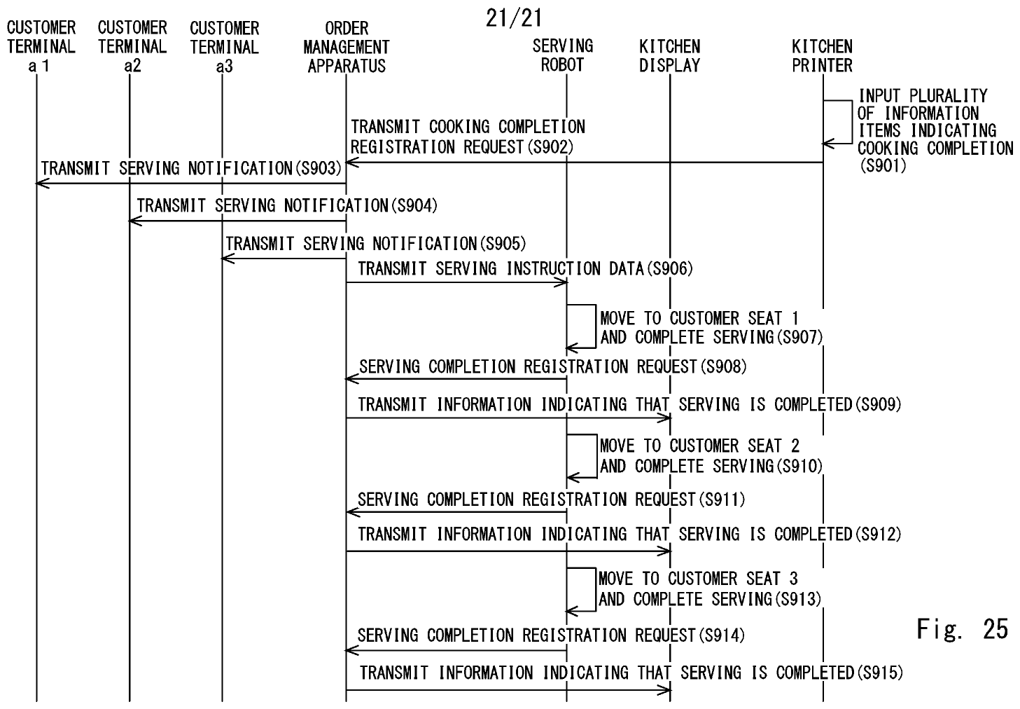

Referring next to FIG. 24, one example of the operation of the order management system 1000 from the accounting to the completion of clearing will be described. FIG. 24 is a sequence chart showing one example of a flow of processing from the accounting to the completion of clearing in the order management method according to the third exemplary embodiment. Note that the sequence chart shown in FIG. 24 is an operation example of the order management system 1000 in a case in which the status of the serving robot 300 is “waiting” when the clearing is instructed.

In the order management method according to the third exemplary embodiment, an “accounting” button is displayed on the display unit 214 included in the customer terminal 230. After a customer finishes eating, he/she selects the “accounting” button displayed on the customer terminal 230. The customer selects the “accounting” button, and then the accounting request unit 219 transmits an accounting request including the customer seat number of the customer seat where the customer terminal 230 is provided to the order management apparatus 900 (Step S801). The order management apparatus 900 performs accounting in accordance with the accounting request (Step S802), and transmits a receipt to the customer terminal 230 (Step S803). The display unit 214 included in the customer terminal 230 outputs the received receipt by displaying the same (Step S804). Since Steps S805-S810 are similar to the aforementioned Steps S502-S507, the descriptions thereof will be omitted.

As described above, in the order management method according to the third exemplary embodiment, a customer orders dishes and pays the bill by himself/herself using the customer terminal 230. Therefore, contacts between floor staff members and customers can be reduced. Further, the amount of work performed by the floor staff members is reduced, whereby the operation in the floor 10 is further improved.

While the case in which both an order of dishes and accounting are performed from the customer terminal 230 has been described in the third exemplary embodiment, only one of the order of dishes and accounting may be performed from the customer terminal 230. For example, the order of dishes may be performed from the customer terminal 230 and the accounting may be performed from the order management apparatus 900.

### Fourth Exemplary Embodiment

A fourth exemplary embodiment is a modified example of the above-described second exemplary embodiment. In the fourth exemplary embodiment, a serving robot 300 carries dishes to a plurality of serving destinations in a predetermined order. In the following, an order management system according to the fourth exemplary embodiment will be described, but the descriptions overlapping with those in the second exemplary embodiment and the like will be omitted as appropriate. The order management system according to the fourth exemplary embodiment has a configuration similar to that of the order management system 800 described in the second exemplary embodiment.

FIG. 25 is a sequence chart showing one example of a flow of processing from the completion of cooking to the completion of serving in an order management method according to the fourth exemplary embodiment. In the fourth exemplary embodiment, a cooking staff member places cooked dishes on a plurality of respective trays included in the serving robot 300 along with order slips. The dishes placed on one tray are served to one destination. For example, in the example shown in FIG. 14, a cooking staff member places dishes to be served to a customer seat 1 on a tray in the upper stage, places dishes to be served to a customer seat 2 on a tray in the middle stage, and places dishes to be served to a customer seat 3 on a tray in the lower stage. Note that customer terminals a1-a3 shown in FIG. 14 are customer terminals 210 provided in the customer seats 1-3, respectively.

After a cooking staff member places dishes and order slips on each tray, the cooking staff member inputs information indicating that cooking of each dish has been completed into the cooking completion registration request unit 421 included in the kitchen printer 420 (Step S901). In Step S901, the cooking staff member inputs tray data of the tray on which each dish is placed. The cooking completion registration request unit 421 transmits a cooking completion registration request to the order management apparatus 700 based on the content input by a cooking staff member (Step S902). The order management apparatus 700 receives the cooking completion registration request, and then the serving notification unit 760 included in the order management apparatus 700 transmits a serving notification to each customer terminal 210 provided in each customer seat corresponding to the serving destination data included in the cooking completion registration request (Steps S903-S905).

After the order management apparatus 700 receives the cooking completion registration request, the serving control unit 730 included in the order management apparatus 700 generates serving instruction data including a plurality of serving destination data items included in the cooking completion registration request, and transmits the generated serving instruction data to the serving robot 300 (Step S906). The serving instruction data transmitted in Step S906 includes data of a predetermined order in which the serving robot 300 moves to a plurality of customer seats. The predetermined order is not particularly limited. In the example shown in FIG. 14, for example, the serving robot 300 moves from the serving destination of the dishes placed in the upper stage of the tray, the serving destination of the dishes placed in the middle stage of the tray, and the serving destination of the dishes placed in the lower stage of the tray in this order. Further, the serving robot 300 may move, for example, to each of the serving destinations in series from the serving destination where the order has been made at the earliest timing.

Upon receiving the serving instruction data, the serving robot 300 moves to the customer seat 1 based on the serving destination data included in the serving instruction data and completes serving (Step S907). After the serving is completed, the serving robot 300 transmits a serving completion registration request including the customer seat number (serving destination data) of the customer seat 1 to the order management apparatus 900 (Step S908). The order entry unit 710 transmits information indicating that the serving to the customer seat 1 has been completed to the kitchen display 410 (Step S909).

Next, the serving robot 300 moves to the customer seat 2 and completes serving (Step S910). After the serving is completed, the serving robot 300 transmits a serving completion registration request including the customer seat number (serving destination data) of the customer seat 2 to the order management apparatus 900 (Step S911). The order entry unit 710 transmits information indicating that the serving has been completed to the customer seat 2 to the kitchen display 410 (Step S912).

Next, the serving robot 300 moves to the customer seat 3 and completes serving (Step S913). After the serving is completed, the serving robot 300 transmits a serving completion registration request including the customer seat number (serving destination data) of the customer seat 3 to the order management apparatus 900 (Step S914). The order entry unit 710 transmits information indicating that the serving to the customer seat 3 has been completed to the kitchen display 410 (Step S915).

As described above, in the order management method according to the fourth exemplary embodiment, the serving robot 300 is able to serve dishes to a plurality of serving destinations in a predetermined order. Therefore, the serving robot 300 is able to serve a number of dishes at one time. In the order management method according to the fourth exemplary embodiment, the serving robot 300 may clear the dishes in a plurality of customer seats in a predetermined order. Further, in the order management method according to the fourth exemplary embodiment, the serving robot 300 may use at least one of a plurality of trays to serve dishes and use the other remaining trays to clear dishes.

### OTHER EXAMPLE EMBODIMENTS

While the above-described example embodiments have been described as hardware configurations, this is merely examples. The present disclosure may implement desired processing by causing a CPU to execute a computer program.

In the aforementioned examples, the program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

According to the present disclosure, it is possible to provide an order management apparatus, a system, a method, and a program for automatically sending a clearing instruction after accounting is completed.

Note that the present invention is not limited to the aforementioned example embodiments and may be changed as appropriate without departing from the spirit of the present invention. Further, the present disclosure may be executed by combining the example embodiments as appropriate.

The whole or part of the example embodiments disclosed above can be described as, but not limited to, the following supplementary notes.

(Supplementary Note A1)

An order management apparatus comprising:
order entry means for transmitting, when order data including dish data and serving destination data is input, the order data to a kitchen apparatus;
order data storage means for storing the order data;
serving control means for generating, when cooking of a dish is completed, serving instruction data including serving destination data of the dish and transmitting the serving instruction data to a serving robot;
accounting means for performing accounting based on the order data; and
clearing control means for generating clearing instruction data including the serving destination data of the serving destination for which the accounting has been completed and transmitting the clearing instruction data to the serving robot.

(Supplementary Note A2)

The order management apparatus according to Supplementary Note A1, further comprising cooking status management means for transmitting a cooking status of the dish to the kitchen apparatus,
wherein the order data storage means stores the cooking status in association with the dish data.

(Supplementary Note A3)

The order management apparatus according to Supplementary Note A2, wherein the cooking status management means changes, when the serving robot completes serving the dish, the cooking status of the dish to serving completed.

(Supplementary Note A4)

The order management apparatus according to Supplementary Note A2, further comprising serving notification means for sending, after the cooking status of the dish is changed to cooking completed, a serving notification to a customer terminal.

(Supplementary Note A5)

The order management apparatus according to Supplementary Note A4, wherein the order entry means registers the order data in the order data storage means based on an order data registration request received from the customer terminal.

(Supplementary Note A6)

The order management apparatus according to Supplementary Note A4 or A5, wherein the accounting means performs accounting based on an accounting request received from the customer terminal.

(Supplementary Note A7)

The order management apparatus according to Supplementary Note A1, wherein the clearing control means transmits, in a case in which the serving robot is in operation when the clearing instruction data is transmitted, the clearing instruction data to a staff terminal.

(Supplementary Note A8)

The order management apparatus according to Supplementary Note A1, wherein
the order data storage means stores a plurality of serving destination data items and dish data input in each of serving destinations in association with each other as each of order data items, and
the serving control means transmits serving instruction data for causing the serving robot to serve each of the dishes that have been cooked to each of the corresponding serving destinations in a predetermined order.

(Supplementary Note B1)

An order management system comprising:
an order input terminal configured to input order data including dish data and serving destination data;
an order management apparatus capable of communicating with the order input terminal;
a serving robot that is configured to carry a cooked dish and is capable of communicating with the order management apparatus; and
a kitchen apparatus capable of communicating with the order management apparatus, in which
the order management apparatus includes:
   order entry means for transmitting, after receiving the order data from the order input terminal, the order data to the kitchen apparatus;
   order data storage means for storing the order data;
   serving control means for generating, after receiving information indicating that cooking of the dish has been completed from the kitchen apparatus, serving instruction data including serving destination data of the dish and transmitting the serving instruction data to a serving robot;
   accounting means for performing accounting based on the order data; and
   clearing control means for generating clearing instruction data including the serving destination data of the serving destination for which the accounting has been completed and transmitting the clearing instruction data to the serving robot.

(Supplementary Note B2)

The order management system according to Supplementary Note B1, wherein
the order management apparatus further comprises a cooking status management unit configured to transmit a cooking status of the dish to the kitchen apparatus, and
the order data storage means stores the cooking status in association with the dish data.

(Supplementary Note C1)

An order management method, wherein a computer performs the following processing of:
transmitting, when order data including dish data and serving destination data is input, the order data to a kitchen apparatus;
storing the order data;
generating, when cooking of a dish is completed, serving instruction data including serving destination data of the dish, and transmitting the serving instruction data to a serving robot;
performing accounting based on the order data; and
generating clearing instruction data including the serving destination data of the serving destination for which the accounting has been completed and transmitting the clearing instruction data to the serving robot.

(Supplementary Note D1)

An order management program for causing a computer to execute:
transmission processing for transmitting, when order data including dish data and serving destination data is input, the order data to a kitchen apparatus;
storing processing for storing the order data;
transmission processing for generating, when cooking of a dish is completed, serving instruction data including serving destination data of the dish, and transmitting the serving instruction data to a serving robot;
accounting processing for performing accounting based on the order data; and
transmission processing for generating clearing instruction data including the serving destination data of the serving destination for which the accounting has been completed and transmitting the clearing instruction data to the serving robot.

The first, second, third and fourth embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An order management apparatus comprising:
at least one memory; and
at least one processor coupled to the at least one memory, wherein
the at least one memory stores order data including dish data and serving destination data, and
the at least one processor performs the following processing of:
transmitting, when order data including dish data and serving destination data is input, the order data to a kitchen apparatus;
generating, when cooking of a dish is completed, serving instruction data including serving destination data of the dish, and transmitting the serving instruction data to a serving robot;
performing accounting based on the order data; and
generating clearing instruction data including the serving destination data of the serving destination for which the accounting has been completed and transmitting the clearing instruction data to the serving robot.

2. The order management apparatus according to claim 1, wherein
the at least one processor transmits a cooking status of the dish to the kitchen apparatus, and
the at least one memory stores the cooking status in association with the dish data.

3. The order management apparatus according to claim 2, wherein the at least one processor changes, when the serving robot completes serving the dish, the cooking status of the dish to serving completed.

4. The order management apparatus according to claim 2, wherein the at least one processor sends, when the cooking status of the dish is changed to cooking completed, a serving notification to a customer terminal.

5. The order management apparatus according to claim 4, wherein the at least one processor registers the order data in the at least one memory based on an order data registration request received from the customer terminal.

6. The order management apparatus according to claim 4, wherein the at least one processor performs accounting based on an accounting request received from the customer terminal.

7. An order management method, wherein a computer performs the following processing of:
transmitting, when order data including dish data and serving destination data is input, the order data to a kitchen apparatus;
storing the order data;
generating, when cooking of a dish is completed, serving instruction data including serving destination data of the dish, and transmitting the serving instruction data to a serving robot;
performing accounting based on the order data; and
generating clearing instruction data including the serving destination data of the serving destination for which the accounting has been completed and transmitting the clearing instruction data to the serving robot.

8. A non-transitory computer readable medium storing an order management program for causing a computer to execute:
transmission processing for transmitting, when order data including dish data and serving destination data is input, the order data to a kitchen apparatus;
storing processing for storing the order data;
transmission processing for generating, when cooking of a dish is completed, serving instruction data including serving destination data of the dish, and transmitting the serving instruction data to a serving robot;
accounting processing for performing accounting based on the order data; and
transmission processing for generating clearing instruction data including the serving destination data of the serving destination for which the accounting has been completed and transmitting the clearing instruction data to the serving robot.
